(19) United States
(12) Patent Application Publication
(10) Pub. No.: US 2006/0281825 A1
(43) Pub. Date: Dec. 14, 2006

(54) Microporous Polyisocyanate Based Hybrid Materials

(76) Inventors: Je Kyun Lee, Brookline, MA (US); Wendell E. Rhine, Belmont, MA (US)

Correspondence Address: ASPEN AEROGELS INC.;IP DEPARTMENT, 30 FORBES ROAD, BLDG. B, NORTHBOROUGH, MA, 01532, US

(21) Appl. No.: 11/423,635

(22) Filed: Jun. 12, 2006

Related U.S. Application Data
(60) Provisional application No. 60/689,706, filed on Jun. 11, 2005.

(51) Int. Cl. C08J 9/00

(52) U.S. Cl. 521/50

(57) ABSTRACT

The present invention describes hybrid gel materials with interpenetrating polyisocyanate and inorganic polymer networks. In the preferred embodiments, the polyisocyanate network comprises polyurea, polyurethane or both while the inorganic network comprises silica.

### CROSS REFERENCE TO RELATED APPLICATIONS

This application claims the benefit of priority from U.S. Provisional Application Ser. No. 60/689,706 filed on Jun. 11, 2005; the contents of which are hereby incorporated by reference as if fully set forth.

### DESCRIPTION

Aerogels are well regarded for their light weight and low thermal conductivity among other properties. This type of material maybe prepared from organic, inorganic or hybrid organic inorganic precursors. For instance an aerogel material may be based on polyurethanes or polyureas which describe polymers containing a plurality of urethane (—NH—CO—O—) or urea (—NH—CO—NH—) groups, respectively, in their molecular chain. The most common method of preparing a polyurethane is the condensation reaction of a diisocyanate (—NCO) and a polyol (—OH), while polyurea is prepared by a condensation reaction of a diisocyanate (—NCO) and polyamine (—NH₂). However, isocyanates also can be polytrimerized to form a 3-dimensional crosslinked polyisocyanurate polymer network. The structure of polyurethane or polyurea can be complex and diverse, containing “hard” and “soft” segments (cross-linkages), which contribute to the balance between rigid and rubbery properties. In order to adjust the rubbery behavior, number of cross-linkages, cross-linkage chain lengths, type of cross-linkages or a combination thereof may be adjusted.

However, polyol and polyamine hardeners (cross-linkers) contributing to more rubbery properties are generally less reactive with the isocyanate resin (polyisocyanate) due to for example fewer hydroxyl and amine groups or larger chains. Lower reactivity of these polymeric hardeners used for rubbery behavior can be a serious problem in aerogel processing, because aerogel products are generally prepared from very dilute solutions, containing low solid content. No gelation or very slow gelation is frequently observed from these less crosslinkable and more rubbery systems. Moreover, organic polymer aerogels prepared with constituent components with higher molecular weights generally exhibit much higher thermal conductivity values than those of inorganic aerogels such as silica which may be due to less pore volumes and lower surface areas. However, for many applications requiring exceptional flexibility, there is a need to develop less stiff and non-fragile aerogels without deteriorating the desirable properties of aerogels.

A promising method to improve both thermal and mechanical properties would be to provide a hybrid system between an organic and an inorganic polymer structure, especially interpenetrating organic-inorganic networks. The interpenetrating network formation is actually used to improve mechanical properties of silica aerogels. A recent invention discloses that the aerogels with interpenetrating organic-inorganic networks are more flexible and elastic than aerogels not modified with organic polymer networks. Aerogels with interpenetrating organic-inorganic networks are, therefore, to be especially preferred in cases where mechanical loads are involved, since they show significant advantages in this respect over brittle, purely inorganic aerogels, while the improved thermal conductivity properties would be advantageous over purely (rubbery) organic aerogels.

Several methods of synthesis of IPNs, particularly focusing on simultaneous and sequential interpenetrating network formation have been demonstrated. In one method, interpenetrating polymer networks (IPNs) are a product of a combination of two or more network polymers, synthesized in juxtaposition. In the simultaneous IPN method, the monomers or polymers plus hardener and catalyst or activator are mixed and the two polymers are simultaneously polymerized or vulcanized independently to form two networks which are interpenetrated with each other. Sequential IPNs are formed through the different crosslinking reaction kinetics. In another method, after the network of one polymer is formed, the other monomer or polymer hardener and catalyst swollen into the first network is polymerized in situ. Semi-IPNs have one or more cross-linked phase or network and one or more of the polymers are linear or branched. It is possible to extract these non-cross-linked networks with certain solvents. In addition to these IPN formation methods, more IPN methods and materials such as semi-IPN, latex IPN, gradient IPN, and thermoplastic IPN were introduced. The IPN systems must be cast since, once the components are admixed and the polymer formation takes place. The interpenetrating networks cannot be separated. For the present invention, the simultaneous IPNs (or sequential IPNs with little different cross linking reaction between two inorganic and organic networks) are particularly important.

In non-porous polymeric systems, the simultaneous IPN is illustrated in U.S. Pat. No. 4,302,553 of Frisch et al. This sort of IPN involves a blend of two different prepolymers cross-linked in independent processes and permanently entangled with one another. Arkles, et al. developed silicone semi-IPN formed in thermoplastic polymer matrices by the vulcanization of a hydride group-containing silicon with a polymer containing unsaturated groups, summarized in U.S. Pat. No. 4,302,553. For microporous systems, Novak et al., (Novak B. et al., “Low-Density, Mutually Interpenetrating Organic-Inorganic Composite Material via Supercritical Drying Technique” Chem. Mater, 6, 282 (1994)) attempted to develop a simultaneous interpenetrating acrylamide-silica network in which the organic polymer was generated in situ during the sol-gel reaction by radical polymerization of a vinyl polymer. However, they reported that their attempts to perform the sol-gel process in a solution of organic polymers usually failed, because the polymer was washed out during supercritical drying.

Embodiments of the present invention describe organic-inorganic hybrid gel materials comprising interpenetrating organic and inorganic networks. In one embodiment the organic network is based on a polyisocyanate whereas the inorganic network is based on a metal oxide. In one aspect the hybrid gel materials of the present invention comprise distinct three dimensional organic and inorganic networks, wherein said networks are substantially free of covalent bonds therebetween. That is, substantially free of stable chemical bonds between the organic network and the inorganic network. Production of hybrid gel materials according to embodiments of the present invention involves forming (i.e. polymerization into) an organic three dimensional polymeric network(s) and an inorganic three dimensional polymeric network(s) that are mutually interpenetration from a mixture comprising precursors for both.

The temporal relationship between formation of each network can vary with the proviso that they are both allowed to form a three dimensional network throughout the volume of the mixture comprising precursors for the two. In one embodiment, formation of the hybrid gel material gel formation is carried out such that initiation of the inorganic network is carried out before that of the organic network. Conversely, in another embodiment, formation of the hybrid gel material gel formation is carried out such that initiation of the organic network is carried out before that of the inorganic network. In yet another embodiment, formation of the organic and inorganic networks are simultaneously initiated.

For sake of clarity, gel formation refers to the formation of the organic network, inorganic network, or both. Generally gel formation is understood as the point at which a mixture exhibits decreased flow, or a point where a continuous polymeric network is formed throughout. As used herein “polyisocyanate” refers to molecules comprising more than one isocyanate (NCO) functional group, which further includes oligomers and polymers derived from polymerization thereof. Further, “isocyanate resins” describe compositions serving as a source of polyisocyanates. Finally, “polyol” and “polyamine” refer to monomers, oligomers or polymers comprising more than one hydroxyl (OH) and amine (primary, secondary and tertiary) functional groups respectively. Within the context of embodiments of the present invention “aerogels” or “aerogel materials” along with their respective singular forms, refer to gels containing air as a dispersion medium in a broad sense, and refer to gel materials dried via supercritical fluids in a narrow sense.

### DETAILED DESCRIPTION

By way of example the inorganic network is formed from silica precursors while it is noted that numerous other metal oxide precursors may replace, or be used in conjunction with silica. Examples of other metal oxides include but are not limited to: titania, zirconia, alumina, hafnia, yttria and ceria.

The typical synthetic route for the production of a silica aerogel is through gel formation by hydrolysis of a silicon alkoxide followed by condensation reactions. This system can be also referred to as the sol-gel process which is described further in Brinker C. J., and Scherer G. W., Sol-Gel Science; New York: Academic Press, 1990; hereby incorporated by reference. Suitable silicon alkoxides for use in embodiments of the present invention are tetra alkoxysilanes (Si(OR)₄) having C₁-C₆ alkoxy groups or aryloxy groups. Typical examples include methoxy, ethoxy, n-propoxy, n-butoxy, 2-methoxyethoxy, and phenylphenoxy groups. Preferred examples of such compounds containing C₁-C₃ alkoxy group include tetraethoxysilane (TEOS), tetramethoxysilane (TMOS), and tetra-n-propoxysilane. These materials can also be partially hydrolyzed and stabilized at low pH as polymers of polysilicic acid esters such as polydiethoxysiloxane. Such polymers of polysilicic acid esters in alcohol solution are commercially available. Optionally, in order to produce gels with somewhat less dense and brittle structures, organotrialkoxysilanes (R′Si(OR)₃) can be used as silica precursors or added as a co-precursor with the tetra functional alkoxysilane precursor. The R′ groups need not be the same on a given precursor molecule. Examples of such precursors are methyltriethoxysilane, methyltrimethoxysilane, methyltri-n-propoxysilane, phenyltriethoxysilane, and vinyltriethoxysilane. For use in the present invention, more preferred precursors are the partially hydrolyzed alkoxysilanes which are able to form silica networks fast.

Acid and base catalysts can be used for preparing microporous silica networks. It is well known to sol-gel practitioners that all other factors being equal, acid catalysis produces gels which are cross-linked to a lesser extent than gels produced by base catalysis. Such acid and base catalysts facilitate both hydrolysis and condensation reactions and can play an important role in determining pore structures of the resulting silica network aerogel. Preferred catalysts include organic acids such as acetic acid and inorganic acids such as hydrochloric, nitric, sulfuric, and hydrofluoric acid. Preferred basic catalysts include amines, ammonia, ammonium hydroxide, potassium hydroxide, and potassium fluoride. More preferred acid and base catalysts for use in the present invention are hydrochloric, hydrofluoric, or sulfuric acids for a lower pH solution and ammonium hydroxide for a higher pH.

The amount of catalyst used in silica network formation is dependent on the desired gel time and the type and amount of silicon alkoxide precursor, water content, reaction temperature, solvent type, and the amount of additives incorporated (such as opacifiers and reinforcement materials). Generally the amount of catalyst is preferably such that the total weight, total mole, or the mole ratio between catalyst and silicon alkoxide precursor result in the desired gel time. More specifically the preferred amount of catalyst for use in the present invention is sufficient for the gelation time ranges between 30 second and 6 hours at 23° C., more preferably, between 1 minute and 2 hours at 23° C.

In sol gel processing, hydrolysis reactions can be initiated by water and either acid or base catalyzed conditions. The water content incorporated for the hydrolysis reaction generally plays a role in determining the gel time and properties of the resulting silica aerogel such as mechanical properties, thermal conductivity, and transparency. For fast preparation of silica network, water is preferably incorporated in excess of a stoichiometric minimum amount, even for the case using partially hydrolyzed alkoxysilanes. The amount of water used for the present invention is preferably used in mole ratio of water to silica between 0.5:1 and 12:1, more preferably, between 1:1 and 10:1. If more water is used than mole ratio of 12:1 water to silica, phase separation will occurs due to decreasing solubility between the constituent components and solvents, while if less water is used than mole ratio of 0.5:1, silica to water, the silica sol of the present invention will gel very slowly or not at all.

The solids content in the solution for preparing the silica network aerogel is preferably between 1 and 50% by weight, more preferably between 2 and 45% by weight, most preferably between 3 and 40% by weight which includes all individual values within the stated ranges.

Isocyanate resins for use in the present method for preparing the polyurethane or polyurea network include aliphatic, cycloaliphatic, araliphatic, heterocyclic and aromatic diisocyanates such as those which are described in U.S. Pat. No. 6,150,489 hereby incorporated by reference. Included among preferred isocyanate resins are the following examples: aliphatic diisocyanates such as 1,6-hexamethylene diisocyanate, cycloaliphatic diisocyanates such as isophorone diisocyanate, 1,4-cyclohexane-diisocyanate, 1-methyl-2,4-cyclohexane diisocyanate, 1-methyl-2,6-cyclohexane diisocyanate and corresponding mixtures of isomers; 4,4′-dicyclohexylmethane diisocyanate, 2,4′-dicyclohexylmethane diisocyanate, 2,2′-dicyclohexylmethane diisocyanate and corresponding mixtures of isomers; aromatic diisocyanates such as toluene 2,4-diisocyanate (TDI), mixtures of toluene 2,4-diisocyanate and toluene 2,6-diisocyanate, 4,4′-diphenylmethane diisocyanate (MDI), 2,4′-diphenylmethane diisocyanate and 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates and 2,4′-di-phenylmethane diisocyanates, 4,4′-diisocyanato-diphenylethane-(1,2) and 1,5-naphthylene diisocyanate, and isocyanate such as triphenylmethane 4,4′,4″-triisocyanate or polymethylene polyphenylene isocyanates (polymeric MDI) having an isocyanate functionality of greater than 2 and the so-called MDI variants (MDI modified by the introduction of urethane, allophanate, urea, biuret, carbodiimide, uretonimine or isocyanurate residues). Of particular importance are aromatic isocyanate resins such as TDI and the corresponding isomeric mixtures, MDI and the corresponding isomeric mixtures, and polymeric MDI. These isocyanate resins are commercially available from Bayer, Dow, BASF, Huntsman, Imperial, Lyondell, Shell, and Degusa.

At least one isocyanate resin is used in amounts ranging from 0.5 to 30% by weight depending on the theoretical target density, preferably from 1 to 25% by weight, and more preferably from 2 to 20% by weight based on the total reaction mixture.

The group that is reactive with isocyanate group in the monomer or polymer for use in the present method may be hydroxyl, thiol, amine, epoxy, or other group containing the reactive hydrogen functionality. More preferable the reactive groups for use in the present invention are hydroxyl functional groups for preparing polyurethane networks and amine functional group for preparing polyurea networks. Accordingly, the polyisocyanate based network comprises polyurea, polyurethane (or both) depending on the choice of hardner.

Examples of suitable hardeners containing hydroxyl functional group for use in the present method for preparing the polyurethane network aerogels include 1,2-propane diol; 1,4-butane diol, 1,5-pentane diol, 1,6-hexane diol, 1,7-heptane diol, ethylene glycol, diethylene glycol, tetraethylene glycol, 1,2-propylene glycol, 1,3-propylene glycol, dipropylene glycol, 1,2-butylene glycol, 1,3-butylene glycol, 1,4-butylene glycol, glycerine, glycerol, 1,1,1-trimethylolpropane, 1,1,1-trimethylolethane, hexane- 1,2,6-triol, alpha-methyl glucoside, pentaerythritol, erythritol and sorbitol, as well as pentols and hexols, glucose, sucrose, fructose, maltose and compounds derived from phenols such as (4,4′-hydroxyphenyl)2,2-propane, bisphenols, alkylphenols such as dodecylphenol, octylphenol, decylphenol, polyester polyols, polyether polyols, modified polyether polyols, polyester ether polyols, castor oil polyols, and polyacrylate polyols. Hardeners containing OH functional groups for preparing the polyurethane network are polyether polyols. In order to provide both good rubbery behavior and fast reactivity with isocyanate resins, polymer hardeners containing OH functional groups can be selected from polyether polyol specially modified with ethylene oxide. The fast gel formation by the fast reaction of polyol hardener with isocyanate is also one of the important factors considered in commercial processing of aerogel products. Suitable polyether polyols may be produced in accordance with any of the known methods of prior art. Such polyether polyols are commercially available, for example, under the trademark by Multranol of Bayer Corporation and Voranol of Dow Chemical Company.

The preferred polyether polyol for use in the present invention has an OH equivalent between 30 and 1000 mg KOH/g, more preferably between 50 and 800 mg KOH/g, the preferable functionality of greater than 2, more preferably greater than 3. The average molecular weight of the polyether polyol is preferably between 100 and 6000, more preferably between 200 and 4000. Examples of such polyether polyols that are commercially available, are Multranol 9181, Multranol 9187, Multranol 4050, Multranol 9171, Multranol 4030, Multranol 8117, and Multranol 9185 (all available from Bayer Corporation). Other commercially available polyether polyols are, for example, Voranol 230-238, Voranol 230-660, Voranol 360, Voranol 391, Voranol 446, Voranol 490, Voranol 520, and Voranol 800 (all available from Dow Chemical Company).

The amount of polyol hardeners conforms to a specific ratio range between functional groups in the polyol hardener (OH) and in the isocyanate resin (NCO). This specific ratio range of functional groups between the polyol hardener and the isocyanate resin allows for providing fast and uniform gel formation of the polyurethane mixture of the present invention as well as good thermal and physical properties. If more isocyanate is used than the optimum amount, gelation is relatively faster, but a less rubbery and brittle aerogel (after drying) would be formed. While, if less isocyanate is used, very rubbery xerogels are frequently generated through phase separation or there is no gelation. The preferred ratio range of functional groups in polyol hardener (OH) and in isocyanate resin (NCO) is between 0.01:1 and 1:1, more preferably between 0.05:1 and 0.5:1.

Examples of suitable hardeners containing amine or amino functional groups for use are ethylenediamine, 1,4-butanediamine, 1,6-hexanediamine, N-methylcyclohexylamine, polyethyleneamine, and polyoxyalkyleneamines (polyetheramines). A preferred monomer hardeners containing amine functional group are ethylenediamine, 1,4-butanediamine, and 1,6-hexanediamine. More preferred polymer hardeners containing amine functional group for use in the present invention for preparing rubbery polyurea based aerogel monoliths and composites are polyoxyalkyleneamines such as polyoxyethylene-propylenemonoamines, polyoxypropylenediamines, and polyoxypropylenetriamines. The preferred average molecular weight of the polyoxyalkyleneamines is preferably larger than 50, more preferably larger than 150. Such polyoxyalkyleneamines are commercially available, for example, Jeffamine D-230, Jeffamine T-403, Jeffamine D-400, Jeffamine M-2005 (XTJ-507), Jeffamine D-2000, Jeffamine D-4000 (XTJ-510), Jeffamine T-3000 (XTJ-509), and Jeffamine T-5000 from Huntsman Corporation.

Similar to incorporation method of polyol hardeners, the amount of polyamine hardeners are used in a specific ratio between functional groups in the polyamine hardener (—NH₂) and in the isocyanate resin (NCO). As in polyurethane aerogels, the ratio of functional groups between polyamine hardener and the isocyanate is important in the properties of the resulting polyurea network. If more isocyanate is used than the preferred amount, fast gelation occurs but aerogel becomes less rubbery, and more brittle and dusty. If more polyamine hardener is used than the preferred amount, very rubbery xerogel is formed by phase separation or no gelation occurs depending on the ratio of functional groups. The preferred ratio between functional groups in the polyamine hardener (NH₂) and in the isocyanate resin (NCO) is between 0.01:1 and 1:1, more preferably between 0.05:1 and 0.6:1.

If polyurethane is used for the organic aerogel network in the hybrid gel materials a more flexible and less fragile aerogel results (after drying) with better thermal conductivity at low pressures. If polyurea is used for the organic network the system generally shows fast gelation with less flexibility, and better thermal conductivity at ambient conditions for the resultant aerogel.

The preferred catalysts for use in the present method for preparing the polyurethane or polyurea network include any of those catalysts known in the prior arts to promote urethane and urea reactions such as aliphatic and aromatic primary, secondary and tertiary amines, or a long chain alkyl amine compound. Examples include ethylamine, 1-benzofuran-2-amine, 4-quinolylamine, [1,1′-binaphthalene-3,3′,4,4′-tetrayl]tetraamine, p-aminobenzoic acid, dimethylamine, N-methylethanamine, diethylamine, N-methylisopropylamine, N-isopropylcyclobutanamine, N, 2-dimethyl-3-pentanamine, N,N-dimethylethanamine, N-methyldiethanamine, N-ethyl-N-methyl-3-hexanamine, didecylmethylamine (DAMA-1010 amine, available from Albemarl Corporation), and especially tin compounds such as stannous octoate and dibutyltin Dilaurate. Tin compounds commercially available from Atofina Chemicals, Inc. include stannous bis (2-Ethylhexoate) (FASCAT 2003), dibutyltin diacetate (FASCAT 4200), and dibutyltin dilaurate (FASCAT 4202). The preferable catalysts for use in the present invention also include any isocyanate trimerisation catalyst such as quaternary ammonium hydroxides, alkali metal and alkaline earth metal hydroxides, alkoxides and carboxylates. Examples include potassium acetate, potassium 2-ethylhexoate, non-basic metal carboxylates (lead octoate), and symmetrical triazine derivatives. Commercially available preferred trimerisation catalysts for use in the present method are Tris(dimethylaminopropyl)hexahydrotriazin (Polycat 41), N-hydroxypropyltrimethyl ammonium-2-ethylhexanoate (DABCO TMR), 2-hydroxypropyl trimethylammonium formate (DABCO TMR-2), and N-hydroxy-alkyl quarternary ammonium carboxylate (DABCO TMR-4) available from Air Products. More preferable catalysts for use in the present method are triethylamine, triethanolamine diphenylamine, didecylmethylamine (DAMA-1010), stannous bis (2-E thylhexoate) (FASCAT 2003), dibutyltin diacetate (FASCAT 4200), tris(dimethylaminopropyl)hexahydrotriazin (Polycat 41), N-hydroxypropyltrimethyl ammonium-2-ethylhexanoate (DABCO TMR), and 2-hydroxypropyl trimethylammonium formate (DABCO TMR-2).

The amount of catalyst for preparing the polyurethane or polyurea network depends on the desired gel time and the amount of isocyanate resin and hardener material, the reaction temperature, solvent type, and the amount of additives incorporated (such as opacifiers and reinforcement material.) Also, it is preferred to use catalysts that are diluted in a solvent. The catalyst amount for the present invention is preferably used in the ratio between the total weight of catalyst and isocyanate resin and polyol hardeners for preparing the polyurethane network or polyamine hardeners for preparing polyurea network. The preferred catalyst amount for preparing the polyurethane or polyurea network is the amount needed so that the gelation time of polyurethane or polyurea mixture solution occurs preferably between 30 seconds and 6 hours at 23° C., more preferably, between 1 minute and 2 hours at 23° C.

The solids content in the solution for preparing the polyurethane or polyurea network is preferably between 1 and 50% by weight, more preferably between 2 and 45% by weight, most preferably between 3 and 40% by weight.

The solvent should be non-reactive with silicon alkoxides, partially hydrolyzed alkoxysilane, 3-dimensionally polymerized silica gel and polymer, and catalyst in the presence of water as well as initial isocyanate resins, polyol or polyamine hardeners, 3-dimensionally polymerized polyurethane or polyurea gel and polymer, and catalyst. The preferred solvents are those compatible with sol-gel reaction kinetics allowing for formation of a uniform wet gel, and solubility of constituent components in the presence of water. Suitable solvents for use in the present invention include alcohols such as methanol, ethanol, and propanol; amides such as formamide, dimethylformamide; ketones such as acetone and methyl ethyl ketone; nitriles such as acetonitrile; and aliphatic or alicyclic ethers such as diethyl ether, tetrahydrofuran, and dioxane. Particularly preferred solvents for use in the present invention are acetone, methyl ethyl ketone, tetrahydrofuran, and dioxane.

The solvent amount for preparing the polyurethane or polyurea network depends on the desired gel density and additives used (such as opacifiers and reinforcement material). The solvent can be used in an amount to provide theoretical (or target) density. However, most often the final density is generally higher than the theoretical target density, because of shrinkages during the aging drying steps. The amount of solvent used is preferably in such that the density of the resulting microporous interpenetrating silica-polyisocyanate network ranges from 0.01 g/cm³ to 0.5 g/cm³, preferably from 0.02 g/cm³ to 0.45 g/cm³, more preferably from 0.03 g/cm³ to 0.4 g/cm³.

In order to further improve thermal and/or mechanical properties, structural integrity, and the handling of the gel monoliths, IR opacifiers and/or reinforcement materials can be incorporated in the sol-gel process, preferably in an amount of between 0.05 and 50% by weight based on the weight of isocyanate resin and hardener material. Examples of suitable IR opacifiers and reinforcement materials include carbon black (solution), carbon fiber, boron fiber, ceramic fiber, rayon fiber, nylon fiber, olefin fiber, alumina fiber, asbestos fiber, zirconia fiber, alumina, clay, mica, silicas, calcium carbonate, titanium dioxide, talc, zinc oxide, barium sulfates, and wood.

Example of other opacifiers include: B₄C, Diatomite, manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or a mixture thereof.

Aerogels may be reinforced with a fibrous structure for further reinforcement. Suitable fibrous structures for embodiments of the present invention include, but are not limited to wovens, non-wovens, mats, felts, battings (e.g. lofty batting) and combinations thereof

The fiber batting material may be used at the bottom and/or top of the mold in which the monolith is cast to give structural strength. Alternately, all the materials in a sol or slurry form can be infused into a fibrous batting and allowed to gel. Examples of such a fiber batting include: polyester fibers, polyolefin terephthalates, poly(ethylene) naphthalate, polycarbonates and Rayon, Nylon, cotton-based lycra (manufactured by DuPont), carbon-based fibers like graphite, precursors for carbon fibers like polyacrylonitrile(PAN), oxidized PAN, uncarbonized heat-treated PAN (such as the one manufactured by SGL carbon), fiberglass based material like S-glass, 901 glass, 902 glass, 475 glass, E-glass, quartz, Quartzel (manufactured by Saint-Gobain), Q-felt (manufactured by Johns Manville), alumina fibers like Saffil (manufactured by Saffil), Durablanket (manufactured by Unifrax), polyaramid fibers like Kevlar, Nomex, Sontera (all manufactured by DuPont), Conex (manufactured by Teijin), polyolefins like Tyvek (manufactured by DuPont), Dyneema (manufactured by DSM), Spectra (manufactured by Honeywell), polypropylene fibers like Typar and Xavan (both manufactured by DuPont), fluoropolymers like PTFE with trade names such as Teflon (manufactured by DuPont), Goretex (manufactured by GORE), silicon carbide fibers like Nicalon (manufactured by COI Ceramics), Nextel fibers (manufactured by 3M), acrylic fibers, fibers of wool, silk, hemp, leather, suede, PBO-Zylon fibers (manufactured by Tyobo), liquid crystal material like Vectan (manufactured by Hoechst), Cambrelle fiber (manufactured by DuPont), polyurethanes, polyamides, wood fibers, and boron, aluminum, iron, stainless steel fibers, and thermoplastics like PEEK, PES, PEI, PEK, and PPS.

Aerogel composites reinforced with a fibrous batting, herein referred to as “blankets”, are particularly useful for applications requiring flexibility since they are highly conformable and provide low thermal conductivity. Aerogel blankets and similar fiber-reinforced aerogel composites are described in published U.S. patent application Ser. No. 2002/0094426A1 and U.S. Pat. Nos. 6,068,882, 5,789,075, 5,306,555, 6,887,563, and 6,080,475.

The silicon alkoxide and isocyanate resin mixtures can be prepared separately or one mixture may be prepared comprising both precursors. There are various modes for practicing embodiments of the present invention.

One method comprises the steps of:
a) mixing at least one polyisocyanate;
   at least one hardner; and
   at least one inorganic precursor;
b) forming a gel from said mixture; and
c) drying the gel

another method comprises the steps of:
a) combining a first mixture comprising at least one polyisocyanate and at least one hardner, with a second mixture comprising at least one inorganic precursor thereby forming a third mixture;
b) forming a gel from said third mixture; and
c) drying the gel

In either method catalysts, as previously described, may be added to promote gel formation of the organic network, inorganic network or both. Of course gel formation may be also achieved with supply of an energy form in lieu of, or in conjunction with, the catalysts (chemical catalyst.) Exemplary energy forms include but are not limited to: electromagnetic, acoustic, or particle radiation, heat, ultrasonic energy, ultraviolet light, gamma radiation, electron beam radiation, and the like can be exposed to a sol material to induce gelation.

Numerous methods are possible for combining a fibrous structure and gel precursor mixture to form the fiber-reinforced hybrid gel materials presently described one method comprises the steps of:
(a) dispensing a mixture comprising at least one hardner, at least one isocyanate resin and at least one inorganic precursor, into a fibrous structure;
(b) forming a gel from said mixture; and
(c) drying the gel.

Another method comprises the steps of:
(a) introducing a fibrous structure into a mixture comprising at least one hardner, at least one isocyanate resin and at least one inorganic precursor;
(b) forming a gel from said mixture; and
(c) drying the gel.

Yet another method comprises the steps of:
(a) dispensing a first mixture comprising:
   at least one hardner and at least one isocyanate resin; or
   at least one inorganic precursor;
   into a fibrous structure;
(b) dispensing a second mixture comprising:
   at least one hardner and at least one isocyanate resin; or
   at least one inorganic precursor;
   into said fibrous structure wherein said second mixture comprises different precursors than said first mixture;
(c) forming a gel from the mixture resulting from the combination of first and second mixtures; and
(d) drying the gel.

The silicon alkoxide and isocyanate resin solution are used to provide the desired range of theoretical target densities from 0.01 g/cm³ to 0.5 g/cm³, preferably from 0.02 g/cm³ to 0.45 g/cm³, more preferably from 0.03 g/cm³ to 0.4 g/cm³. The preferred difference of the target densities between silicon alkoxide and isocyanate resin mixtures should be less than 75%, more preferably, less than 50%. If the target densities are mismatched by more than 75%, phase separation will occur and interpenetrating silica-polyisocyanate based network will be broken or absent.

Preferably the mixture comprising both precursors is left standing for a period of time to form the polymeric silica and polyisocyanate gel network. This time period varies from less than 30 seconds to several days, even weeks and months, depending on the types of ingredients, catalyst content, water content, the ratio between functional groups in the isocyanate resin and in the hardener, and the target density (solid content). The gelation time is preferably between 30 seconds and 6 hours. More preferably between 1 minute to 2 hours. For the formation of interpenetrating silica-polyisocyanate based network, the preferred gel time difference between two precursor mixtures is less than 1 hr, more preferably, less than 30 minutes. If there is a greater difference in gel time between silicon alkoxide and isocyanate solutions, phase separation will occur and interpenetrating silica-polyisocyanate based network will not form. Temperatures between −10° C. and 60° C., preferably 0° C. and 50° C. can be employed as the gelation temperature.

In order to form uniform wet gel for easier handling during subsequent processing, it is preferred that they be stabilized at room temperature for a short period. This step is important in processing weak gels prepared with lower target density. The typical period for this process varies from 5 minutes to 20 hours at room temperature, preferably between 20 minutes and 2 hours.

Although the mixture gels with 3 dimensionally crosslinked interpenetrating network within a few seconds, minutes, or hours, it has been found to be advantageous to age (post-cure) the wet gels at elevated temperatures for a certain period of time so as to obtain a stronger gel that can be easily handled during subsequent processing. Aging at higher temperatures reduces the time needed to obtain a stronger gel. Therefore, the wet gels are aged at elevated temperatures for a certain period of time until the weak polymeric wet gels, especially those with low target densities, becomes strengthened. The preferable aging period for use in the present invention varies from 1 hour to several days, more preferably, ranges from 2 hours to 48 hrs. Aging temperatures ranges from 0° C. to 100° C., preferably from 10° C. to 80° C. Preferred aging solvents for use in the present invention include alcohols such as methanol, ethanol, and propanol, ketones such as acetone and methyl ethyl ketone, nitriles such as acetonitrile, and aliphatic or alicyclic ethers such as diethyl ether, tetrahydrofuran, and dioxane. More preferred solvents for use in the present invention are methanol, ethanol, acetone, methyl ethyl ketone, tetrahydrofuran, and dioxane. The aging solvent is preferably added in an amount sufficient to form a solvent layer over wet gel surface. Optionally, the aging solution can contain hydrophobic agents and catalyst, for example hexamethyldisilazane, to improve the hydrophobicity of the silica network and promote further post curing. Also, the aged wet gel can be washed with fresh solvent after aging and before drying. Drying plays an important role in engineering the properties of aerogels, such as porosity and density which in turn influence the material thermal conductivity. To date, numerous drying methods have been explored. U.S. Pat. No. 6,670,402 teaches drying via rapid solvent exchange of solvent(s) inside wet gels using supercritical CO₂ by injecting supercritical, rather than liquid, CO₂ into an extractor that has been pre-heated and pre-pressurized to substantially supercritical conditions or above to produce aerogels. U.S. Pat. No. 5,962,539 describes a process for obtaining an aerogel from a polymeric material that is in the form a sol-gel in an organic solvent, by exchanging the organic solvent for a fluid having a critical temperature below a temperature of polymer decomposition, and supercritically drying the fluid/sol-gel. U.S. Pat. No. 6,315,971 discloses processes for producing gel compositions comprising: drying a wet gel comprising gel solids and a drying agent to remove the drying agent under drying conditions sufficient to minimize shrinkage of the gel during drying. Also, U.S. Pat. No. 5,420,168 describes a process whereby Resorcinol/Formaldehyde aerogels can be manufactured using a simple air drying procedure. Finally, U.S. Pat. No. 5,565,142 describes subcritical drying techniques. The embodiments of the present invention can be practiced with drying using any of the above techniques. In some embodiments, it is preferred that the drying is performed at vacuum to below super-critical pressures (pressures below the critical pressure of the fluid present in the gel at some point) and optionally using surface modifying agents.

The preferable supercritical drying for the present invention includes placing the solvent-filled gel in a temperature-controlled pressure vessel and bringing the vessel to a pressure above the critical pressure of CO₂ by filling with CO₂ gas or pumping liquid CO₂. In another embodiment, before the supercritical drying step, the solvent filled in the wet gel can be exchanged by a liquid carbon dioxide. Modifiers, for example, surfactants to reduce the interfacial energy, can be added to the carbon dioxide to make the gels more suitable for supercritical drying. At that point the vessel is then heated above the critical temperature of the CO₂. After a few hours the pressure is slowly released from the vessel while keeping a constant temperature. After the pressure vessel cools down at atmospheric pressure, the dried interpenetrating silica-polyisocyanate based network aerogels are removed from the vessel.

The microporous silica-polyisocyanate based aerogels prepared accordingly comprise pores in the nanometer range between about 0.1 to about 200 nm, more generally in the range 1 to 100 nm obtained by the Brunauer-Emmet-Teller (BET) nitrogen adsorption method. The average pore diameter is calculated as 4V/A with V=cumulative pore volume per gram of material and A=specific surface area. The cumulative pore volumes per gram of material are generally larger than 0.5 cm³/g. BET surface areas of the aerogels prepared are generally larger than 100 m²/g.

In one embodiment, the hybrid aerogel materials of the present invention comprise pores with average size of less than about 100 nm, less than about 50 nm, less than about 20 nm, less than 15 nm or less than about 12 nm.

The thermal conductivity coefficient of the microporous silica-polyisocyanate based aerogel monoliths and composites depends on the final aerogel densities and the ratio of the silicon alkoxide precursor to polyisocyanate components incorporated. At room temperature and atmospheric pressures the interpenetrating silica-polyisocyanate based network aerogels described generally have thermal conductivity coefficients between 5 and 50 mW/m K, more generally between 10 and 40 mW/m K.

The potential applications for these aerogel materials include, not are to limited to, uses for thermal and acoustic insulation, radiation shielding, and vibrational damping materials in aerospace, military, and commercial applications requiring exceptional flexibility. Some examples are: space suit, gloves, footwear, and helmets, systems for warming, storing, and/or transporting food and medicine, sleeping bags and pads, military and recreational cloth and tents. Because of their improved mechanical properties and excellent thermal insulation properties, microporous structure, and large surface area, more applications of the present invention can be included catalyst support, selectively permeable membranes, sensors, packing materials, aircraft, cryogenic tanks, liquefied gas transport, etc.

The following examples are provided to illustrate the embodiments of the present invention. However, these examples are not to be construed as limiting the invention's nature or scope. They are provided for the sole purpose of better illustrating the techniques involved in the present invention.

### Materials

Silica precursor: A partially hydrolyzed and stabilized polymer solution of polysilicic acid esters at low pH in alcohol,

Ammonium hydroxide (NH₄OH): A.C.S. reagent grade containing about 29% ammonia aqueous solution, available from Aldrich.

PAPI 94: a polymeric MDI of polymethylene polyphenylisocyanate containing MDI available from DOW Chemical Company, Inc., having isocyanate equivalent weight of 131.5, NCO content by weight of 32%, functionality of 2.3, and the number average molecular weight of about 290.

Multranol 9185: polyether polyol specially modified with ethylene oxide available from Bayer Corporation, having an OH number of 100 mg KOH/g, functionality of 6, and the number average molecular weight of about 3,400.

Jeffamine D-2000: polyoxypropylenediamine (difuntional primary amine) available from Huntsman Corporation, having an amine hydrogen equivalent weight of 514, total amine of 1.0 meq/g, and the average molecular weight of about 2,000.

Tris(dimethylaminopropyl)hexahydrotriazin (Polycat 41): a trimerisation catalyst available from Air Products and Triethylamine (TEA): a tertiary amine catalyst available from Aldrich.

### EXAMPLE 1

The silicon alkoxide and the isocyanate solutions were separately prepared and combined. 69.52 mL of silica precursor was weighed into a polypropylene container that had a screw cap. Subsequently, 22.48 mL of acetone was added and the mixture was stirred to obtain a homogeneous solution. Next, 23.4 mL of water was added to the solution and blended thoroughly. In another polypropylene container, 4.82 g of Multranol 9185 polyol was weighed and subsequently, 107.24 mL of acetone was added and the mixture was stirred to obtain a homogeneous solution. 7.52 g of PAPI 94 was added to this solution and it was stirred until homogeneous. To this PAPI 94 and polyol solution, 8 mL of Polycat 41 catalyst diluted in acetone (10/90 v/v) was added. Immediately, 15 mL of ammonia solution diluted in acetone (10/90 v/v) was added to silica precursor dropwise. After stirring thoroughly for 1 min, the PAPI 94 and polyol solution were poured into the silica precursor solution. After stirring thoroughly to ensure a homogeneous mixture of silica precursor and isocyanate solutions for 1 min, a timer was started to obtain the gel time. Some of the sols were poured into a plastic container containing a quartz fiber batting to prepare composite samples. The lids on the containers for monoliths and composites were closed airtight and the mixture is maintained in a quiescent state to form an interpenetrating network comprising silica-polyisocyanate gels. After waiting for another 30 min to ensure uniform gelation of the mixture, acetone was added into polymeric gel in an amount to form acetone layer that covers the entire gel surface in order to avoid collapse of pore structure due to evaporation of solvent out of the gel. The wet gels were then aged for 20 hours in an oven preset at 50° C.

Once the aging process was completed and samples were cooled down, the wet gel was washed with fresh acetone to remove any remaining monomers and impurities formed during the aging process. The aged wet gel had a slightly brown color due to the reaction between acetone and ammonia, as disclosed in the U.S. patent application Ser. No. 2002/128,482. The wet gels were loaded into a pressure vessel with a volume of 60 L, while avoiding evaporation of solvent. After closure of the vessel, liquid CO₂ at about 10° C. was introduced through a valve from the top of the vessel and subsequently, the pressure increased to 1500 psig after 10 minutes. Next, the acetone was exchanged with liquid carbon dioxide and the mixture of CO₂ and acetone was withdrawn through a pressure relief system that maintained the pressure inside the vessel at 1500 psig. The mixture of CO₂ and acetone was decompressed and reheated in separators where gaseous CO₂ and liquid acetone were withdrawn, with the CO₂ being recycled through liquefaction and pumping, as commonly practiced in supercritical fluid extraction equipment. When all of the acetone had been exchanged for CO₂, the pressure vessel was heated to 50° C. for 50 minutes to a supercritical point for CO₂. After supercritically drying the sample for 1 hour, the pressure was slowly released from the vessel for a period of 90 min or until atmospheric pressure was reached. The dried interpenetrating silica-polyurethane network aerogel was removed from the vessel.

The resulting aerogel was opaque and had a slightly yellow or orange color due to the effect of the color of the PAPI 94 isocyanate resins and the reaction between acetone and ammonia, which mainly occurred during the aging period. Density of the monolithic interpenetrating silica-polyurethane network aerogel was 0.1335 g/cm³, indicating that the shrinkage factor (final dried density/target density) of about 1.34. This shrinkage factor of interpenetrating silica-polyurethane network aerogel was slightly higher than 1.11 obtained for polyurethane aerogel prepared with the target density of 0.1 g/cm³, but lower than 1.65 for the silica aerogel with the same target density. The pore structure of the obtained gel was characterized by using Brunauer-Emmet-Teller nitrogen adsorption (BET) measurements after degassing at 70° C. for overnight. BET measurements on the first interpenetrating silica-polyurethane network aerogel revealed a surface area of 537 m²/g, a pore volume of 2.15 cm³/g, and an average nanopore diameter of 14.1 nm. Thermal conductivity coefficient at a single temperature was measured in the air at atmospheric pressure and showed 17.5 mW/m K, which was in between that of silica aerogel (14 mW/m K) and that of polyurethane aerogel (21 mW/m K). Quartz fiber reinforced interpenetrating silica-polyurethane network aerogel composite of this example showed a density of 0.1324 g/cm³ and a thermal conductivity coefficient of 17.9 mW/m K.

### EXAMPLE 2

The silicon alkoxide and the isocyanate solutions were separately prepared and combined. 52.14 mL of silica precursor was weighed into a polypropylene container that had a screw cap. Next, 40.81 mL of acetone was added and the mixture was stirred to obtain a homogeneous solution. Then, 17.55 mL of water was added to this solution and blended thoroughly. In another polypropylene container 3.72 g of Multranol 9185 polyol was weighed, and subsequently 110.69 mL of acetone was added and the mixture was stirred to obtain a homogeneous solution. 5.80 g of PAPI 94 was added and the mixture was stirred to obtain a homogeneous solution. To this PAPI 94 and polyol mixture solution, 10 mL of Polycat 41 catalyst solution diluted in acetone (10/90 v/v) was added slowly. Immediately, 20 mL of ammonia solution diluted in acetone (10/90 v/v) were incorporated to the silica precursor solutions slowly. After stirring thoroughly for 1 min, subsequently, the PAPI 94 and polyol solution were poured into silica precursor solution. After stirring thoroughly to ensure a homogeneous mixture of silica precursor and isocyanate solutions for 1 min, the mixture was poured into molds and allowed to gel. Next, the wet gels were aged using the same method as described in Example 1.

Once the aging process was completed, the wet gels were loaded to a pressure vessel and were subsequently supercritically dried using the same method as described in Example 1. The obtained interpenetrating silica-polyurethane network aerogel was opaque and had slightly yellow or orange color due to the effect of the color of PAPI 94 isocyanate resins and the reaction between acetone and ammonia, which mainly occurred during aging period. Density of the obtained gel was 0.1073 g/cm³, which means the shrinkage factor of about 1.43 and was in between that of silica aerogel(1.75) and that of polyurethane aerogel(1.29). The pore structure of the obtained gel was characterized by using Brunauer-Emmet-Teller nitrogen adsorption (BET) measurements after degassing at 70° C. for overnight. BET measurements of the interpenetrating silica-polyurethane network aerogel revealed a surface area of 438 m²/g, a pore volume of 1.09 cm³/g, and an average nanopore diameter of 10.0 nm. Thermal conductivity coefficient at a single temperature was measured in the air at atmospheric pressure and showed 19.8 mW/m K, which was in between that of silica aerogel(13 mW/m K) and that of polyurethane aerogel (25 mW/m K). Quartz fiber reinforced interpenetrating silica-polyurethane network aerogel composite of this example showed a density of 0.1058 g/cm³ and thermal conductivity coefficient of 19.1 mW/m K.

### EXAMPLE 3

The silicon alkoxide and the isocyanate solutions were separately prepared and combined. 32.50 mL of silica precursor was weighed into a polypropylene container that had a screw cap. Subsequently, 55.8 mL of acetone was added and the mixture was stirred to obtain a homogeneous solution. Next, 11.7 mL of water were added in this solution and blended thoroughly. In another polypropylene container 2.42 g of Multranol 9185 polyol was weighed, and subsequently 109.04 mL of acetone was added and the mixture was stirred to obtain a homogeneous solution. 3.77 g of PAPI 94 was added to this solution and it was stirred to obtain a homogeneous solution. To this solution, 15 mL of Polycat 41 catalyst solution diluted in acetone (10/90 v/v) was added slowly. Immediately, 30 mL of ammonia solution diluted in acetone (10/90 v/v) was added to silica precursor solutions slowly. After stirring thoroughly for 1 min, subsequently, the PAPI 94 and polyol solution was poured into silica precursor silicon alkoxide solution. After stirring thoroughly for 1 min, the solution was poured into molds and allowed to gel. Next, the wet gels were aged using the same method as described in Example 1.

Once the aging process was completed, the wet gels were loaded to a pressure vessel and were subsequently supercritically dried using the same method as described in Example 1. The resulting aerogel was opaque and had slightly yellow or orange color due to the effect of the color of PAPI 94 isocyanate resins and the reaction between acetone and ammonia, which mainly occurred during the aging period. Density of the resulting aerogel monolith was 0.0755 g/cm³, which means lower shrinkage factor (final dried density/target density) of about 1.51 and was in between that of silica aerogel (1.82) and that of polyurethane aerogel(1.36). The pore structure of the obtained gel was characterized by using Brunauer-Emmet-Teller nitrogen adsorption (BET) measurements after degassing at 70° C. for overnight. BET measurements on the first interpenetrating silica-polyurethane network aerogel revealed a surface area of 357 m²/g, a pore volume of 0.89 cm³/g, and an average nanopore diameter of 8.76 nm. Thermal conductivity coefficient at a single temperature was measured in the air at atmospheric pressure and showed 21.1 mW/m K, which was in between that of silica aerogel (11 mW/m K) and that of polyurethane aerogel(28 mW/m K). Quartz fiber reinforced interpenetrating silica-polyurethane network aerogel composite of this example showed a density of 0.0732 g/cm³ and thermal conductivity coefficient of 22.2 mW/m K.

### EXAMPLE 4

The silicon alkoxide and the isocyanate solutions were prepared in one batch. 69.52 mL of silica precursor was weighed into a polypropylene container that had a screw cap. Subsequently, 143 mL of acetone was added and the mixture was stirred to obtain a homogeneous solution. 4.82 g of Multranol 9185 were added in this solution and blended until a homogeneous solution was obtained. Next, 15.6 mL of water were added in this mixture solution and blended, subsequently, 7.51 g of PAPI 94 was added and the mixture was stirred to obtain a homogeneous solution. To this solution, 8 mL of Polycat 41 catalyst solution diluted in acetone (10/90 v/v) and 15 mL of ammonia solution diluted in acetone (10/90 v/v) were successively added slowly. After stirring thoroughly for 1 min, the solution was poured into molds and allowed to gel. Next, the wet gels were aged using by the same method as described in Example 1.

Once the aging process was completed, the wet gels were loaded to a pressure vessel and were subsequently supercritically dried using the same method as described in Example 1. The resulting aerogel was opaque and had slightly yellow or orange color due to the effect of the color of PAPI 94 isocyanate resins and the reaction between acetone and ammonia, which mainly occurred during aging period. Density of the obtained aerogel monolith was 0.1287 g/cm³, which means lower shrinkage factor (final dried density/target density) of about 1.29. The pore structure of the obtained gel was characterized by using Brunauer-Emmet-Teller nitrogen adsorption (BET) measurements after degassing at 70° C. for overnight. BET measurements on the first interpenetrating silica-polyurethane network aerogel revealed a surface area of 477 m²/g, a pore volume of 1.98 cm³/g, and an average nanopore diameter of 13.7 nm. Thermal conductivity coefficient at a single temperature was measured in the air at atmospheric pressure and showed 20.5 mW/m K. Quartz fiber reinforced interpenetrating silica-polyurethane network aerogel composite of this example showed a density of 0.1224 g/cm³ and thermal conductivity coefficient of 20.7 mW/m K.

### EXAMPLE 5

The silicon alkoxide and the isocyanate solutions were separately prepared and combined. 69.52 mL of silica precursor was weighed into a polypropylene container that had a screw cap. Subsequently, 33.88 mL of acetone was added and the mixture was stirred to obtain a homogeneous solution. Next, 15.6 mL of water were added in this mixture solution and blended thoroughly. In another polypropylene container 3.46 g of Jeffamine D-2000 polyoxypropylenediamine was weighed and subsequently, 110.75 mL of acetone was added and the mixture was stirred to obtain a homogeneous solution. 8.84 g of PAPI 94 was added and the mixture was stirred to obtain a homogeneous solution. To this PAPI 94 and polyamine mixture, 8.47 mL of TEA catalyst solution diluted in acetone (10/90 v/v) was added. Immediately, 20 mL of ammonia solution diluted in acetone (10/90 v/v) was added into silica precursor silicon alkoxide solutions. After stirring thoroughly for 1 min, subsequently, the PAPI 94 and polyamine solution poured into silica precursor silicon alkoxide solution. After stirring thoroughly for 1 min, the solution was poured into molds and allowed to gel. Next, the wet gels were aged by the same method as described in Example 1.

Once the aging process was completed, the aged wet gels had slightly brown color due to the reaction between acetone and ammonia as described in Example 1. The wet gels were loaded to a pressure vessel and was supercritically dried using the same method as described in Example 1. The obtained interpenetrating silica-polyurea network network aerogel was opaque and had slightly yellow color due to the effect of the color of PAPI 94 isocyanate resins and the reaction between acetone and ammonia, which mainly occurred during aging period. The density of the obtained aerogel monolith was 0.1329 g/cm³, which indicates a shrinkage factor (final dried density/target density) of about 1.33 and was between that of the silica aerogel (1.65)and that of the polyurea aerogel(1.20). The pore structure of the obtained gel was characterized by using Brunauer-Emmet-Teller nitrogen adsorption (BET) measurements after degassing at 70° C. for overnight. BET measurements on the first interpenetrating silica-polyurea network aerogel revealed a surface area of 498 m²/g, a pore volume of 2.13 cm³/g, and an average nanopore diameter of 15.2 nm. Thermal conductivity coefficient at a single temperature was measured in the air at atmospheric pressure and showed 16.9 mW/m K, which was in between that of silica aerogel (14 mW/m K) and that of polyurethane aerogel (20 mW/m K). Quartz fiber reinforced interpenetrating silica-polyurea network aerogel composite of this example showed a density of 0.1315 g/cm³ and thermal conductivity coefficient of 17.2 mW/m K.

1. A method of preparing a porous gel material with interpenetrating organic and inorganic networks comprising the steps of:
a) mixing at least one isocyanate resin;
at least one hardner; and
at least one inorganic precursor;
b) forming a gel from said mixture; and
c) drying said gel.

2. The method of claim 1 wherein the mixture further comprises at least one catalyst.

3. The method of claim 1 wherein said at least one isocyanate resin comprises an aromatic diisocyanate.

4. The method of claim 3 wherein the aromatic diisocyanate comprises toluene diisocyanate, diphenylmethane diisocyanate, polymethylene polyphenylene polyisocyanates, or isomers thereof or any combination thereof.

5. The method of claim 1 wherein said at least one hardner comprises a polyol or a polyamine.

6. The method of claim 1 wherein the formed gel comprises a polyurea or polyurethane network.

7. The method of claim 1 wherein the inorganic precursor comprises: silica, titania, zirconia, alumina, hafnia, yttria, ceria or a combination thereof.

8. The method of claim 1 wherein the gel is dried using a supercritical fluid.

9. The method of claim 10 wherein the gel is dried using supercritical CO₂.

10. The method of claim 1 wherein the dried gel has a thermal conductivity between about 10 and about 30 mW/mK at ambient pressure and 20° C.

11. The method of claim 5, wherein the polyol has an OH number between 50 and 800 mg KOH/g.

12. The method of claim 11 wherein the polyol has an average molecular weight between about 200 and about 4000.

13. The method of claim 5 wherein the polyamine comprises polyoxyethylene-propylenemonoamines, polyoxypropylenediamines, polyoxypropylenetriamines or a combination thereof.

14. The method of claim 13 wherein the polyamine has an average molecular weight greater than 150.

15. The method of claim 5 wherein the ratio between the hydroxyl functional groups in the polyol and isocyanate functional groups in the isocyanate resin is between about 0.05:1 and about 0.5:1 respectively.

16. The method of claim 5 wherein the ratio between the amine functional groups in the polyamine and the isocyanate functional groups in the isocyanate resin is between about 0.05:1 and about 0.6:1 respectively.

17. The method of claim 1 further comprising the step of combining the mixture with a fibrous structure.

18. The method of claim 17 wherein the fibrous structure comprises wovens, non-wovens, mats, felts, battings, lofty batting or any combinations thereof.

19. The method of claim 1 wherein the mixture further comprising additives comprising: organic or inorganic fillers, antioxidants, fibers, IR opacifiers, or combinations thereof.

20. The method of claim 1, wherein density of the dried gel is between about 0.03 g/cm³ and about 0.4 g/cm³.

21. The method of claim 1 wherein the dried gel has a BET average pore sizes in the range of about 10 and 50 nm.

22. The method of claim 1, wherein the BET surface areas of the dried gel is greater than about 100 m²/g.

23. A gel material according to the method of claim 1.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. A hybrid aerogel material comprising mutually interpenetrating polyisocyanate and inorganic polymer networks; wherein said hybrid aerogel material is substantially free of covalent bonds between the polyisocyante and the inorganic network and exhibiting a thermal conductivity between about 10 and about 30 mW/mK at ambient pressure and 20° C.

48. The hybrid aerogel material of claim 47 wherein the polyisocyanate network comprises polyurea, polyurethane or both.

49. The hybrid aerogel of claim 47 wherein the inorganic polymer network comprises: silica, titania, zirconia, alumina, hafnia, yttria, ceria or a combination thereof.

50. The hybrid aerogel of claim 47 further comprising a fibrous structure.

51. The hybrid aerogel of claim 50 wherein the fibrous structure comprises wovens, non-wovens, mats, felts, battings, lofty batting or any combinations thereof.

52. The hybrid aerogel of claim 47 further comprising additives comprising: organic or inorganic fillers, antioxidants, fibers, IR opacifiers, or combinations thereof.

53. The hybrid aerogel of claim 47 having a density between about 0.03 g/cm³ to about 0.4 g/cm³.

54. The hybrid aerogel of claim 47 having a BET average pore sizes in the range of about 10 to 50 nm.

55. The hybrid aerogel of claim 47 having a BET surface area greater than about 100 m²/g.
